(19) United States
(12) Patent Application Publication
(10) Pub. No.: US 2014/0360380 A1
(43) Pub. Date: Dec. 11, 2014

(54) Heating Cooking Device

(71) Applicants: Kentaro Kishira, Osaka-shi (JP); Noboru Iwata, Osaka-shi (JP); Masaki Hamamoto, Osaka-shi (JP); Tazuko Kitazawa, Osaka-shi (JP); Hideki Etoh, Osaka-shi (JP); Teruhisa Kotani, Osaka-shi (JP); Takayuki Naka, Osaka-shi (JP); Yoshiteru Murakami, Osaka-shi (JP)

(72) Inventors: Kentaro Kishira, Osaka-shi (JP); Noboru Iwata, Osaka-shi (JP); Masaki Hamamoto, Osaka-shi (JP); Tazuko Kitazawa, Osaka-shi (JP); Hideki Etoh, Osaka-shi (JP); Teruhisa Kotani, Osaka-shi (JP); Takayuki Naka, Osaka-shi (JP); Yoshiteru Murakami, Osaka-shi (JP)

(73) Assignee: SHARP KABUSHIKI KAISHA, Osaka-shi, Osaka (JP)

(21) Appl. No.: 14/365,684

(22) PCT Filed: Sep. 5, 2012
(86) PCT No.: PCT/JP2012/072540

§ 371 Date: Jun. 16, 2014

(30) Foreign Application Priority Data
Dec. 26, 2011 (JP) 2011-282852

(51) Int. Cl. H05B 6/80; H05B 6/64

(52) U.S. Cl. CPC H05B 6/80; H05B 6/6447; H05B 6/6458; H05B 6/645
USPC 99/331

(57) ABSTRACT

A heating cooking device 1 includes: a heating unit 5 which heats an object to be heated C; an electromagnetic wave generation unit 15 which radiates electromagnetic waves E having a frequency of 100 GHz to 120 THz towards the object to be heated C for determining a cooking state of the object to be heated C; an electromagnetic wave detection unit 16 which detects the electromagnetic waves E radiated by the electromagnetic wave generation unit 15; and a CPU 13 which determines a cooking state of the object to be heated C based on a signal output by the electromagnetic wave detection unit 16 which detects the electromagnetic waves E. The heating cooking device 1 detects the electromagnetic waves E, an intensity of which is changed by striking the object to be heated C and determine the cooking state of the object to be heated C.

### TECHNICAL FIELD

The present invention relates to a heating cooking device which performs heating cooking with respect to an object to be heated.

### BACKGROUND ART

A heating cooking device of the related art is disclosed in PTL 1. This heating cooking device of the related art includes a heating chamber including an opening to be closed by a door at the front thereof, in a main body housing. An object to be cooked which is an object to be heated is accommodated in this heating chamber. As a method of heating an object to be heated, a heating method using radiant heat, heat convection, or microwaves is used.

In such a heating cooking device, a heating cooking method of performing heating while checking a surface state of an object to be heated is performed in the related art. Therefore, the heating cooking device of the related art disclosed in PTL 1 includes color measurement means for measuring a color of a surface of the heated object to be heated. In the heating cooking device, a color of the object to be heated is measured by the color measurement means, and heating means is controlled by a detection signal thereof. Accordingly, an attempt to increase product quality of the object to be heated after the heating has been made.

### CITATION LIST

### Patent Literature

PTL 1: Japanese Unexamined Patent Application Publication No. 2008-151431

### SUMMARY OF INVENTION

### Technical Problem

However, a change in a color may not occur on the surface of the object to be heated even when the object is heated, or the color thereof may be changed but the color change may not be recognized by the color measurement means, due to effects of a material or a state of the object to be heated, a cooking method, a support member of the object to be heated (a container or a loading base), and the like. Accordingly, in the heating cooking device of the related art disclosed in PTL 1, a detection signal generated by the color measurement means may not be changed, and the heating means may not be controlled.

In detail, in a case where a surface of a rice cake is moderately scorched when heating the rice cake in an oven, for example, a color of the surface of the rice cake changes from white to brown or black. Therefore, in the heating cooking device of the related art described above, a preferred scorched degree can be automatically obtained by controlling the heating by using the color measurement means. However, in a case where it is desired to complete the heating cooking without scorching the surface of the rice cake, since the color of the surface of the rice cake does not change from white, the heating cooking device of the related art described above may not deal with such a case.

In addition, a part of a surface of a fish which is desired to be heated with a grill, may already have a tinge of black before heating, and for example, a change in a color of this black part may not be recognized by the color measurement means. Accordingly, in the heating cooking device of the related art described above, it is not possible to determine a preferable scorched state and proper heating control may not be performed.

In a case of heating gratin put in a container which is opaque with respect to visible light, in an oven, for example, a change in a color of some part of the gratin facing air in the heating chamber can be recognized by the color measurement means. However, a change in a color of some part of the gratin facing the container may not be recognized by the color measurement means. Accordingly, in the heating cooking device of the related art described above, it is not possible to determine a preferable scorched state and proper heating control may not be performed.

The invention is made in view of such circumstances, and an object of the invention is to provide a heating cooking device capable of checking a cooking state which cannot be recognized from an appearance of an object to be heated, and preferably controlling heating with respect to the object to be heated to realize improvement of heating quality.

### Solution to Problem

In order to solve the problems described above, there is provided a heating cooking device of the present invention including: a heating unit which heats an object to be heated; an electromagnetic wave generation unit which radiates electromagnetic waves having a frequency of 100 GHz to 120 THz towards the object to be heated for determining a cooking state of the object to be heated; an electromagnetic wave detection unit which detects the electromagnetic waves radiated by the electromagnetic wave generation unit; and a calculation unit which determines a cooking state of the object to be heated based on a signal output by the electromagnetic wave detection unit which detects the electromagnetic waves.

The electromagnetic waves in a frequency band described above have a property of being easily absorbed as rotational movement of molecules, intermolecular interaction, or the like of sugars, proteins, fats, minerals, vitamins, water, and the like configuring food. Particularly, since the electromagnetic waves in the frequency band described above have a property of being extremely easily absorbed by water molecules, an intensity of the electromagnetic waves greatly changes, although a change in moisture content of the object to be heated is slight. Accordingly, according to this configuration, the heating cooking device, for example, recognizes the change in moisture content of the object to be heated, by detecting electromagnetic waves, the intensity of which is changed by striking and being reflected by, being scattered by, or passing through the object to be heated. Therefore, the heating cooking device determines the cooking state of the object to be heated.

A constituent element of the food used for determining the cooking state of the object to be heated is not limited to “water” described above, and may be any other constituent elements other than “water”.

In addition, the “electromagnetic waves having a frequency of 100 GHz to 120 THz” described herein are different from so-called microwaves (2.45 GHz) of microwave heating, which are generally used in heating of an object to be cooked which is the object to be heated of the heating cooking. That is, the “electromagnetic wave generation unit” described herein is a constituent element which is different from, for example, a “heating unit” which radiates microwaves to heat an object to be heated.

Further, the “electromagnetic waves having a frequency of 100 GHz to 120 THz” are electromagnetic waves which are safe to a human body and have a water absorption coefficient equal to or greater than 10² cm⁻¹. Since the absorption coefficient is 10² cm⁻¹, the intensity of the electromagnetic waves is decreased by one tenth while the electromagnetic waves move 0.1 mm (=1/10² cm) in water. Since the intensity of electromagnetic wave decreases by one tenth while the electromagnetic waves move 0.1 mm in moisture of the object to be heated, the detection can be sufficiently performed even when noise is generated during the detection. Meanwhile, the water absorption coefficient of the electromagnetic waves having a frequency of lower than 100 GHz may gradually decrease to be lower than 10² cm⁻¹ to decrease detection accuracy. In addition, the effect of the electromagnetic waves having a frequency of higher than 120 THz on a human body may gradually increase.

In the heating cooking device of the configuration described above, the frequency of the electromagnetic waves is equal to or lower than 2.5 THz.

Generally, an amount of heat radiation generated when a temperature of a heating space is increased, increases as a wavelength grows longer, has a peak at a specific wavelength, and monotonously decreases as a wavelength thereof grows longer than that at the peak. A distribution of the heat radiation changes depending on a temperature, and a wavelength thereof at the peak at a temperature around room temperature, for example, is approximately 10 μm, and a wavelength at the peak at 80 degrees is approximately 8 μm. When it is attempted to detect a cooking state of the object to be heated using the electromagnetic waves having a wavelength (frequency) with a great amount of heat radiation, the heat radiation may appear as a noise when detecting the electromagnetic waves. However, in a case of a temperature around room temperature, the amount of the heat radiation becomes equal to or less than one thousandth of the amount thereof at the time of the peak, at a frequency equal to or lower than 2.5 THz (wavelength equal to or longer than 120 μm). As the temperature increases, the frequency at which the amount of the heat radiation becomes equal to or less than one thousandth of the amount thereof at the time of the peak, decreases (wavelength increases). Therefore, according to this configuration, since the electromagnetic waves having a frequency equal to or lower than 2.5 THz (wavelength equal to or longer than 120 μm) are used, the amount of the heat radiation at the time of heating becomes less than one thousandth of the amount thereof at the time of the peak, and an effect on the heat radiation is sufficiently decreased.

The heating cooking device having the configuration described above, further includes a heating chamber which accommodates the object to be heated; and an exhaust unit for discharging gas in the heating chamber to the outside.

According to this configuration, an effect on absorption of the electromagnetic waves due to water vapor or other gases in the heating chamber is decreased. Accordingly, the moisture content of the object to be heated is more accurately detected.

In the heating cooking device having the configuration described above, the electromagnetic waves are radiated towards a plurality of different points, and a plurality of the signals corresponding to the respective electromagnetic waves are output by the electromagnetic wave detection unit.

According to this configuration, the heating cooking device obtains detection signals of the electromagnetic waves striking the plurality of portions of the object to be heated. Alternatively, the heating cooking device obtains detection signals of the electromagnetic waves striking the object to be heated and the electromagnetic waves not striking the object to be heated. The accuracy of the detected moisture content of the object to be heated increases, by comparing the detection signals of the electromagnetic waves obtained from the plurality of portions. In addition, when a cooking state of a certain portion of the object to be heated substantially does not change before and after the heating, for example, by setting a detection signal of this portion as a reference, it is possible to correct a detection signal of the electromagnetic waves of another portion which is easily affected by the temperature of the object to be heated or the water vapor around the object to be heated.

In the heating cooking device having the configuration described above, lengths of radiation paths of the electromagnetic waves radiated towards the plurality of different points, are substantially the same.

According to this configuration, by acquiring a difference between the electromagnetic waves having substantially the same length of radiation path, it is possible to correct a detection signal of the electromagnetic waves which are easily affected by the temperature of the object to be heated or the water vapor around the object to be heated.

In the heating cooking device having the configuration described above, the electromagnetic waves radiated towards the plurality of different points strike a contacting portion of the object to be heated and a support member which supports the object to be heated, and a non-contacting portion of the support member and the object to be heated.

According to this configuration, by acquiring a difference between the electromagnetic waves striking the portions, it is possible to correct a detection signal of the electromagnetic waves which are easily affected by the temperature of the object to be heated or the water vapor around the object to be heated.

In the heating cooking device having the configuration described above, the electromagnetic waves radiated towards the plurality of different points strike a contacting portion of the object to be heated and a support member which supports the object to be heated, and a non-contacting portion of the object to be heated and the support member.

According to this configuration, by acquiring a difference between the electromagnetic waves striking the portions, it is possible to correct a detection signal of the electromagnetic waves which are easily affected by the temperature of the object to be heated or the water vapor around the object to be heated.

The heating cooking device having the configuration described above, further includes a humidity detection unit which detects a humidity around the object to be heated, in which the calculation unit corrects the signal output by the electromagnetic wave detection unit using the humidity detected by the humidity detection unit.

According to this configuration, it is possible to correct for absorption of the electromagnetic waves by the water vapor around the object to be heated, regarding the detection signal of the electromagnetic waves which strike and are reflected by, are scattered by, or pass through the object to be heated. Accordingly, the moisture content of the object to be heated is accurately detected.

The heating cooking device having the configuration described above, further includes a temperature detection unit which detects a temperature of the object to be heated, in which the calculation unit corrects the signal output by the electromagnetic wave detection unit using the temperature detected by the temperature detection unit.

According to this configuration, it is possible to correct for a change in absorbance of the electromagnetic waves with a change in temperature of the object to be heated, regarding the detection signal of the electromagnetic waves which strike and are reflected by, are scattered by, or pass through the object to be heated. Accordingly, the moisture content of the object to be heated is accurately detected.

In the heating cooking device having the configuration described above, the calculation unit determines a cooking state of the object to be heated based on an absolute value of the signal output by the electromagnetic wave detection unit.

According to this configuration, it is possible to determine an amount of water molecules which is a detection target of the object to be heated. Accordingly, a scorched degree of the surface of the object to be heated is recognized, for example.

In the heating cooking device having the configuration described above, the calculation unit determines a cooking state of the object to be heated based on a change of the signal output by the electromagnetic wave detection unit with respect to time.

According to this configuration, it is possible to determine whether or not the amount of water molecules which is a detection target of the object to be heated is changed. Accordingly, a scorched degree of the surface of the object to be heated is recognized, for example.

In the heating cooking device having the configuration described above, a predetermined reference value for an amount of change of the signal output by the electromagnetic wave detection unit with respect to time is included.

According to this configuration, it is possible to easily determine whether or not the amount of water molecules which is a detection target of the object to be heated is changed, by comparing the reference value for the change in amount with respect to time of the output signal of the electromagnetic wave detection unit, and the change of the output signal of the electromagnetic wave detection unit with respect to time. Accordingly, a scorched degree of the surface of the object to be heated is simply recognized, for example.

In the heating cooking device having the configuration described above, the electromagnetic wave detection unit detects the electromagnetic waves passing through the object to be heated, and the calculation unit determines a cooking state of the object to be heated based on a change in location of the electromagnetic waves passing through the object to be heated, which is detectable by the electromagnetic wave detection unit.

According to this configuration, the calculation unit calculates a boundary between locations of the electromagnetic waves which are detectable and not detectable by the electromagnetic wave detection unit. In addition, the calculation unit calculates that a location of the electromagnetic waves passing through the object to be heated before the cooking or in an initial stage of cooking, which are not detectable, is displaced with decreased moisture of the object to be heated, as the heating cooking proceeds. That is, the calculation unit determines a cooking state of the object to be heated based on a change in a location of the electromagnetic waves detectable by the electromagnetic wave detection unit.

In the heating cooking device having the configuration described above, a radiation location of the electromagnetic waves changes.

According to this configuration, location information relating to disposition of the object to be heated in a cooking space is obtained. Accordingly, the electromagnetic waves are radiated with respect to a preferred location of the object to be heated, in order to check the cooking state of the object to be heated. Therefore, the cooking state of the object to be heated is accurately checked.

The heating cooking device having the configuration described above, further includes an indicating unit which indicates a radiation location of the electromagnetic waves.

According to this configuration, since a user can confirm the radiation location of the electromagnetic waves, the object to be heated is easily disposed at a preferred location of the object to be heated, so as to be struck by the electromagnetic waves, in order to check the cooking state of the object to be heated. Therefore, the cooking state of the object to be heated is accurately checked.

In the heating cooking device having the configuration described above, a predetermined reference value for the output of the temperature detection unit is included, and the electromagnetic waves for determining the cooking state of the object to be heated are radiated towards the object to be heated, under conditions that the output of the temperature detection unit is equal to or larger than the reference value after starting cooking of the object to be heated.

According to this configuration, it is possible to determine whether or not the amount of water molecules which is a detection target of the object to be heated is changed, after the object to be heated is sufficiently heated. Accordingly, a scorched degree of the surface of the object to be heated is properly recognized.

The heating cooking device having the configuration described above, further includes a control unit which controls an operation of the heating unit.

According to this configuration, the heating cooking device controls the operation of the heating unit based on the cooking state of the object to be heated determined by the calculation unit. Accordingly, a heating quality of the object to be heated is improved.

The heating cooking device having the configuration described above, further includes a display unit which displays the cooking state of the object to be heated. According to this configuration, the cooking state of the object to be heated may be checked by the user.

### Advantageous Effects of Invention

According to the configurations of the present invention, a constituent element of food which is the object to be heated, for example, moisture content is acquired, by detecting an intensity of the electromagnetic waves which strike and are reflected by, are scattered by, or pass through the object to be heated. Accordingly, with the heating cooking device of the present invention, it is possible to check the cooking state which cannot be recognized from an appearance of the object to be heated. It is possible to provide a heating cooking device which can preferably control heating with respect to the object to be heated based thereon, to improve the heating quality.

### BRIEF DESCRIPTION OF DRAWINGS

FIG. 1 is a perspective view of a heating cooking device according to a first embodiment of the present invention.

FIG. 2 is a front view of a substantially vertical section of a heating cooking device shown in FIG. 1.

FIG. 3 is a block diagram showing a configuration of a heating cooking device shown in FIG. 1.

FIG. 4 is a graph showing a relationship between a heating time of a heating cooking device shown in FIG. 1 and a detection signal of an electromagnetic wave detection unit.

FIG. 5 is a graph showing a relationship between a heating time of a heating cooking device shown in FIG. 1 and a detection signal of an electromagnetic wave detection unit.

FIG. 6 is a flowchart showing a cooking operation of a heating cooking device shown in FIG. 1.

FIG. 7 is a front view of a substantially vertical section of a heating cooking device according to a second embodiment of the present invention.

FIG. 8 is a front view of a substantially vertical section of a heating cooking device according to a third embodiment of the present invention.

FIG. 9 is a front view of a substantially vertical section of a heating cooking device according to a fourth embodiment of the present invention.

FIG. 10 is a front view of a substantially vertical section of a heating cooking device according to a fifth embodiment of the present invention.

FIG. 11 is a front view of a substantially vertical section of a heating cooking device according to a sixth embodiment of the present invention.

FIG. 12 is a front view of a substantially vertical section of a heating cooking device according to a seventh embodiment of the present invention.

FIG. 13 is a flowchart showing a cooking operation of a heating cooking device of FIG. 12.

### DESCRIPTION OF EMBODIMENTS

Hereinafter, heating cooking devices according to embodiments of the present invention will be described with reference to FIG. 1 to FIG. 13.

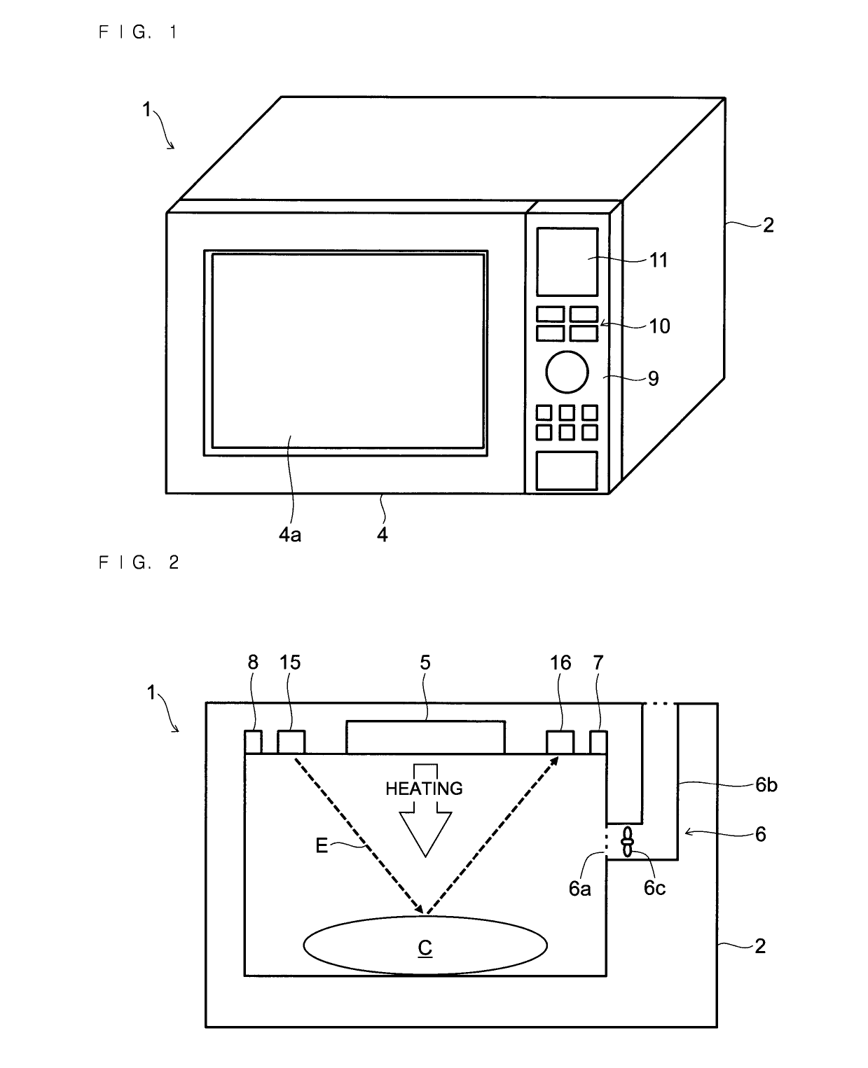

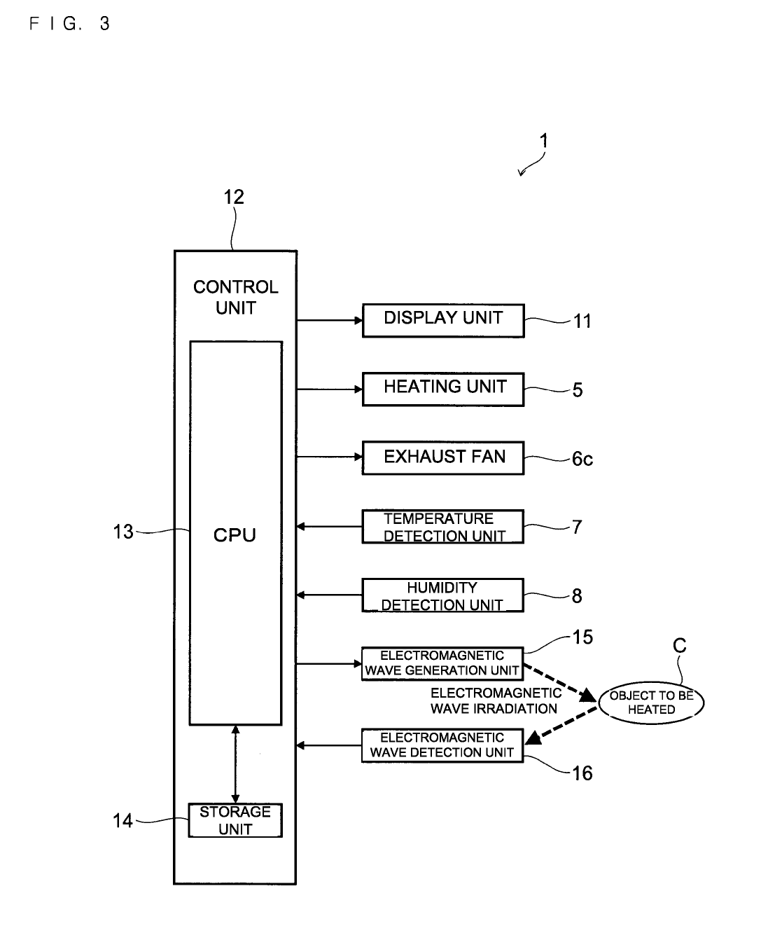

First, a general structure of a heating cooking device according to a first embodiment of the present invention will be described with reference to FIG. 1 to FIG. 3. FIG. 1 is a perspective view of the heating cooking device, FIG. 2 is a front view of a substantially vertical section of the heating cooking device, and FIG. 3 is a block diagram showing a configuration of the heating cooking device.

As shown in FIG. 1 and FIG. 2, the heating cooking device 1 includes a heating chamber 3, a door 4, a heating unit 5, an exhaust unit 6, a temperature detection unit 7, and a humidity detection unit 8 in a main body housing 2 having a rectangular parallelepiped shape.

The heating unit 3 has a rectangular parallelepiped shape and is formed in the main body housing 2. A rectangular opening is provided at the front of the heating chamber 3, and the door 4 which can be opened and closed from the front of the heating cooking device 1 is provided at the opening portion. An object to be heated C which is an object to be cooked is loaded on a bottom plate 3a of the heating chamber 3. The heating chamber 3 retains heat generated by the heating unit 5 and efficiently heats the object to be heated C.

The door 4 includes a transparent window portion 4a with which the inside of the heating chamber 3 can be seen from the outside of the heating cooking device 1. A user can put and take out the object to be heated C in and from the heating chamber 3 by opening the door 4.

An operation panel 9 is provided at the front of the main body housing 2 and at a side portion of the door 4. An operation unit 10 and a display unit 11 are provided on the operation panel 9. The operation unit 10 includes a plurality of keys or a touch panel provided on a surface of the display unit 11, and receives cooking operation such as operation of selection of cooking option, indication of cooking start, indication of cooking stopping, or the like. The display unit 11 is formed of a liquid crystal panel or the like, and displays an operation screen of the operation unit 10 or a progress state of the cooking. In addition, the display unit 11 also can display a message or the like with respect to a user to perform notification to a user.

The heating unit 5 is disposed at an upper portion of the heating chamber 3. The heating unit 5 is a unit for heating the object to be heated C, and can be suitably selected from a microwave transmitter or a heater, according to the purpose of the heating cooking device 1. The disposition position of the heating unit 5 is not limited to the upper portion of the heating chamber 3, and the heating unit 5 may be disposed on a side portion of the heating chamber 3, for example, according to the type of the heating unit 5.

The exhaust unit 6 is disposed on the side portion of the heating chamber 3. The exhaust unit 6 includes an exhaust port 6a, an exhaust duct 6b, and an exhaust fan 6c. The exhaust port 6a opens to one side wall of the heating chamber 3. The exhaust duct 6b which extends to the main body housing 2 so as to communicate with the outside of the heating cooking device 1 is connected to the exhaust port 6a. The exhaust fan 6c is disposed in the exhaust duct 6b and is rotatably driven by a motor (not shown). The exhaust unit 6 rotates the exhaust fan 6c to supply outside air into the heating chamber 3 from an inlet port (not shown), and also allows the air in the heating chamber 3 to flow to the exhaust duct 6b from the exhaust port 6a to be discharged to the outside.

The temperature detection unit 7 is disposed on the upper portion of the heating chamber 3, in order to detect a temperature of the object to be heated C loaded in the heating chamber 3. The temperature detection unit 7 is configured with an infrared temperature sensor which uses a pyroelectric effect for example, and detects the temperature of the object to be heated C by detecting heat radiation of the object to be heated C.

The humidity detection unit 8 is disposed on the upper portion of the heating chamber 3 in order to detect a humidity around the object to be heated C. The humidity detection unit 8 is configured with a capacitance type or electrical resistance type humidity sensor which uses a polymeric humidity-sensitive material, for example.

Herein, the heating cooking device 1 includes a control unit 12 shown in FIG. 3, for the entire operation control thereof. The control unit 12 is configured with a CPU 13 and other electronic components (not shown). The CPU 13 is a central processing unit, and controls constituent elements such as the heating unit 5 or the exhaust unit 6 based on a program or data stored in and input to a storage unit 14, to realize a sequence of heating cooking. In addition, the storage unit 14 previously stores the cooking option or control data of each constituent element of the heating cooking device 1 corresponding to the cooking option.

In the heating cooking device 1 having the configuration described above, when the cooking start is indicated through the operation unit 10, the heating unit 5 or the exhaust unit 6 is driven. Accordingly, the object to be heated C is heated, and the air in the heating chamber 3 is discharged to the outside. The CPU 13 determines the cooking time which is previously set by the operation unit 10 or the cooking option, or a completion time of the cooking based on an output signal of the temperature detection unit 7 or the humidity detection unit 8, and completes the heating cooking.

The heating cooking device 1 having the configuration described above is configured to detect a moisture content of the object to be heated C using electromagnetic waves, in order to realize more efficient heating cooking. The heating cooking device 1 checks a cooking state which cannot be recognized from an appearance of the object to be heated C by checking a change in moisture of the object to be heated C during the heating cooking. Accordingly, the CPU 13 determines that the object to be heated C is in a preferred cooking state for the cooking option, based on the moisture content of the object to be heated C which changes as the heating cooking proceeds, and completes the heating cooking.

In order to realize such heating cooking, the heating cooking device 1 includes an electromagnetic wave generation unit 15 and an electromagnetic wave detection unit 16 shown in FIG. 2 and FIG. 3.

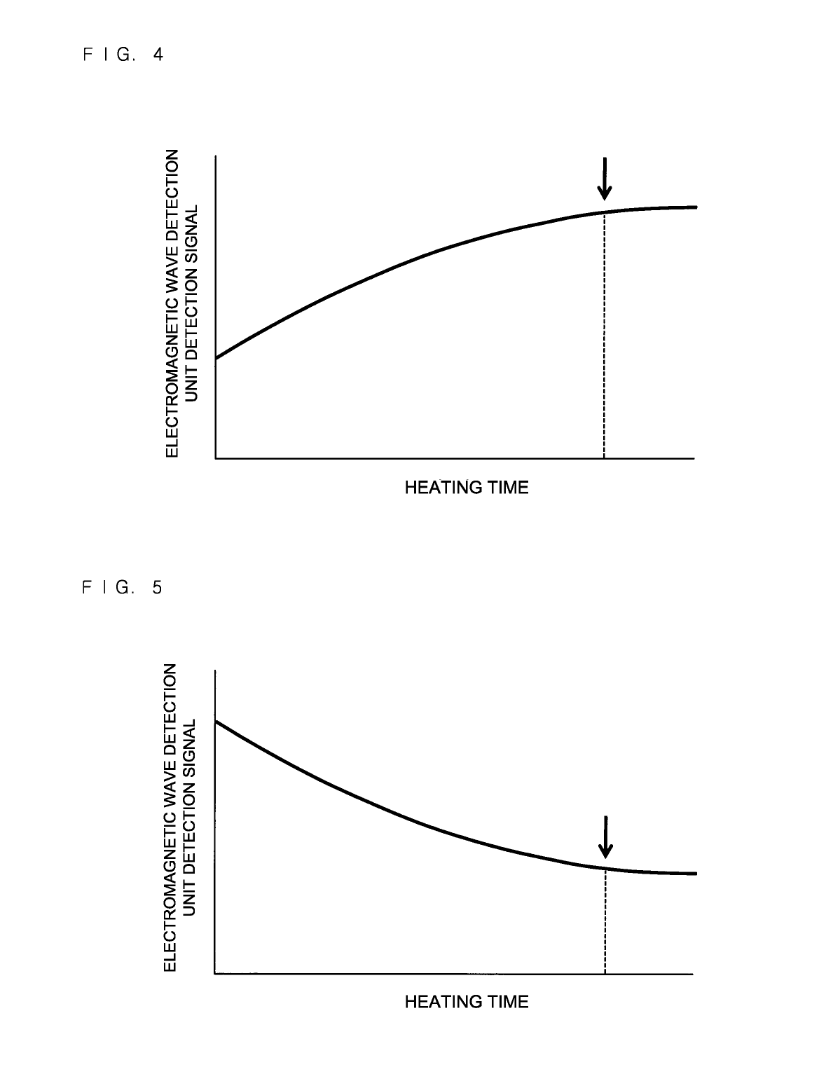

Next, a configuration and an operation of detection of the moisture content of the object to be heated C will be described in detail, with reference to FIG. 4 and FIG. 5, in addition to FIG. 2 and FIG. 3. FIG. 4 and FIG. 5 are graphs showing a relationship between a heating time of a heating cooking device 1 and a detection signal of the electromagnetic wave detection unit 16.

The electromagnetic wave generation unit 15 is disposed on the upper portion of the heating chamber 3. The electromagnetic wave generation unit 15 radiates electromagnetic waves E towards an inside which is a lower portion of the heating chamber 3, that is, the object to be heated C. In addition, dashed line arrows drawn in FIG. 1 show a radiation path and a radiation direction of the electromagnetic waves E. The electromagnetic wave generation unit 15 includes a quantum cascade laser or a resonant tunneling diode, for example, and radiates electromagnetic waves E having a frequency of 100 GHz to 120 THz.

As described above, the electromagnetic wave generation unit 15 is a constituent element which is different from the heating unit 5 which radiates microwaves to heat the object to be heated C, for example. The electromagnetic waves E radiated by the electromagnetic wave generation unit 15 are different from so-called microwaves (2.45 GHz) of microwave heating which is generally used in heating cooking.

The electromagnetic waves having a frequency of 100 GHz to 120 THz are electromagnetic waves which are safe to a human body and have a water absorption coefficient of equal to or greater than 10² cm⁻¹. Since the absorption coefficient is 10² cm⁻¹, the intensity of the electromagnetic waves is decreased by one tenth while the electromagnetic waves move 0.1 mm (−1/10² cm) in water. Since the intensity of the electromagnetic wave decreases by one tenth while the electromagnetic waves move 0.1 mm in moisture of the object to be heated C, the detection can be sufficiently performed even when noise is generated during the detection. Meanwhile, the water absorption coefficient of the electromagnetic waves having a frequency of lower than 100 GHz may gradually decrease to be lower than 10² cm⁻¹ to decrease detection accuracy. In addition, the effect of the electromagnetic waves having a frequency of higher than 120 THz on a human body may gradually increase.

Further, it is desirable that the frequency of the electromagnetic waves E be equal to or lower than 2.5 THz. Generally, an amount of heat radiation generated when a temperature in the heating chamber 3 is increased, increases as a wavelength grows longer, has a peak at a specific wavelength, and monotonously decreases as a wavelength thereof grows longer than that at the peak. A distribution of the heat radiation changes depending on a temperature, a wavelength thereof at the peak at a temperature around room temperature, for example, is approximately 10 μm, and a wavelength at the peak at 80 degrees is approximately 8 μm. When it is attempted to detect a cooking state of the object to be heated C using the electromagnetic waves E having a wavelength (frequency) with great amount of heat radiation, the heat radiation may appear as a noise when detecting the electromagnetic waves E. However, in a case of a temperature around room temperature, the amount of the heat radiation becomes equal to or less than one thousandth of the amount thereof at the time of the peak, at a frequency equal to or lower than 2.5 THz (wavelength equal to or longer than 120 μm). As the temperature increases, the frequency at which the amount of the heat radiation becomes equal to or less than one thousandth of the amount thereof at the time of the peak, decreases (wavelength increases). Therefore, according to this configuration, since the electromagnetic waves E having a frequency equal to or lower than 2.5 THz (wavelength equal to or longer than 120 μm) are used, the amount of the heat radiation at the time of heating becomes less than one thousandth of the amount thereof at the time of peak, and an effect on the heat radiation is sufficiently decreased.

By doing so, the electromagnetic waves E having a frequency of 100 GHz to 120 THz have a property of being extremely easily absorbed by water. Accordingly, if even a little moisture exists in the object to be heated C, the intensity of the electromagnetic waves E greatly changes before and after striking the object to be heated C.

The electromagnetic wave detection unit 16 is disposed on the upper portion of the heating chamber 3. The electromagnetic wave detection unit 16 is disposed at a location at which the electromagnetic waves E which are radiated by the electromagnetic wave generation unit 15, strike, are reflected by or are scattered by the object to be heated C can be detected. By doing so, since the electromagnetic waves E strike and are reflected by or are scattered by the object to be heated C, it is desirable that the electromagnetic wave detection unit 16 be provided on the upper portion of the heating chamber 3 in the same manner as the electromagnetic wave generation unit 15. The electromagnetic wave detection unit 16 includes, for example, an element which uses a pyroelectric effect, a Golay cell, or a Schottky-barrier diode, and detects the electromagnetic waves E radiated by the electromagnetic wave generation unit 15.

In addition, the disposition positions of the electromagnetic wave generation unit 15 and the electromagnetic wave detection unit 16 are not limited to the configuration described above, and may be other disposition positions.

In the heating cooking device 1 including the electromagnetic wave generation unit 15 and the electromagnetic wave detection unit 16, when the cooking start is indicated through the operation unit 10, the electromagnetic waves E are radiated towards the object to be heated C in the heating chamber 3 from the electromagnetic wave generation unit 15 as shown in FIG. 2. When the electromagnetic waves E strike the object to be heated C, the electromagnetic waves are absorbed according to the moisture content of the object to be heated C, and the intensity thereof is changed.

The electromagnetic waves E of which an intensity is changed by striking the object to be heated C, and being reflected by or being scattered by the object to be heated C, are detected by the electromagnetic wave detection unit 16. The CPU 13 calculates a change in moisture content of the object to be heated C based on a signal output by the electromagnetic wave detection unit 16 which detects the electromagnetic waves E. Further, the CPU 13 determines the cooking state of the object to be heated C from the calculation result thereof.

In addition, the temperature detection unit 7 may be used for accurate detection of the moisture content of the object to be heated C. Since the absorption amount of electromagnetic waves E by the object to be heated C is affected by the temperature of the object to be heated C, a temperature change of the object to be heated C disturbs accurate detection of the moisture content of the object to be heated C to be performed by the electromagnetic wave detection unit 16. Accordingly, the heating cooking device 1 detects the temperature of the object to be heated C by the temperature detection unit 7.

In addition, the humidity detection unit 8 may be used for accurate detection of the moisture content of the object to be heated C. Since the electromagnetic waves E are also absorbed by water vapor in the heating chamber 3, fluctuation in a water vapor amount around the object to be heated C affects the detection of the electromagnetic waves E performed by the electromagnetic wave detection unit 16 and disturbs accurate detection of the moisture content of the object to be heated C. Accordingly, the heating cooking device 1 detects the humidity of the air around the object to be heated C by using the humidity detection unit 8.

Next, a correcting method of the moisture content of the object to be heated C, that is, a detection signal output by the electromagnetic wave detection unit 16 will be described.

First, an attenuation of the electromagnetic waves E due to being absorbed by the water vapor around the object to be heated C is calculated. An attenuation rate of the electromagnetic waves E by water vapor has a relationship of an exponential function with respect to the water vapor amount contained in a portion of the electromagnetic waves E which pass through a unit spot area. Herein, the water vapor amount contained in a portion of the electromagnetic waves E which pass through a unit spot area is calculated.

A water vapor amount W contained in a portion of the electromagnetic waves E which pass through a unit spot area can be calculated by Equation (1).

W=L×Y×RH÷100 (1)

Herein, L represents a length of the radiation path of the electromagnetic waves E. As a method of acquiring the length L of the radiation path of the electromagnetic waves E, the same principle as in a general ranging sensor such as triangulation may be used, or a constant value according to a size of the heating chamber 3 may be previously set. RH represents a humidity [%] measured by the humidity detection unit 8. Y represents a saturated vapor amount, and changes depending on a temperature T of the air in the heating chamber 3. The saturated vapor amount Y can be calculated by Equation (2) as a function of the temperature T of the air in the heating chamber 3.

$$\begin{matrix}[ Math 1 ] & \\ Y ( T ) = \frac{217}{T + 273.15} \times 6.1078 \times {10}^{\frac{7.5 T}{T + 237.3}} & ( 2 )\end{matrix}$$

However, the calculation method described above is merely one example, and the saturated vapor amount Y may be calculated by using a function which can be approximated by Equation (2) as a function of the temperature T, or a table for correlating the saturated vapor amount Y and the temperature T may be prepared in advance. The temperature T of the air in the heating chamber 3 may be measured by additionally providing a temperature sensor such as a thermistor.

Next, the attenuation of the electromagnetic waves E by the water vapor is calculated from the calculated water vapor amount W contained in a portion of the electromagnetic waves E which pass through a unit spot area.

As a reference value, the attenuation rate of the electromagnetic waves E in a case where the temperature T is set as T₀ and the humidity RH is set as RH₀ are measured, the attenuation rate thereof is set as D₀. A water vapor amount W₀ contained in the portion of the electromagnetic waves E which pass through the unit spot area at that time, is calculated using the temperature T=T₀ and humidity RH=RH₀.

An attenuation rate D by water vapor contained in the portion of the electromagnetic waves E which pass through the unit spot area can be calculated by Equation (3) by using the water vapor amount W contained in the portion of the electromagnetic waves E which pass through the unit spot area, and the reference attenuation rate D₀ and the reference water vapor amount W₀.

$$\begin{matrix}[ Math 2 ] & \\ D = {D}_{0}^{\frac{W}{{W}_{0}}} & ( 3 )\end{matrix}$$

Finally, a value X₁ for a detection signal X₀ output by the electromagnetic wave detection unit 16 which is obtained by correcting for an effect of the water vapor around the object to be heated C can be calculated by Equation (4).

X₁=X₀÷D (4)

Next, an error due to a change of the absorption amount of the electromagnetic waves E caused by a temperature change of the object to be heated C is calculated and corrected for. Accordingly, in a low temperature state at which the state of the object to be heated C substantially does not change, the temperature change ΔU₀ of the object to be heated C is measured using the temperature detection unit 7. At that time, an amount of change in the detection signal of the electromagnetic wave detection unit 16 is set as Z₀. The amount of change Z of the detection signal of the electromagnetic wave detection unit 16 with respect to a unit temperature increase of the object to be heated C can be calculated by Equation (5).

Z=Z₀÷ΔU₀ (5)

A change Z₁ in the detection signal of the electromagnetic wave detection unit 16 due to the temperature increase of the object to be heated C in a state where the temperature of the object to be heated C is increased by ΔU₁ degrees, can be calculated by Equation (6).

Z₁=Z×ΔU₁ (6)

At that time, a value X₂ obtained by correcting for an effect of the temperature increase of the object to be heated C, with respect to the detection signal X₁ obtained by correcting for the effect of the water vapor can be calculated by Equation (7).

X₂=X₁+Z₁ (7)

By doing so, the CPU 13 corrects the detection signal output by the electromagnetic wave detection unit 16 using the temperature of the object to be heated C detected by the temperature detection unit 7 and the humidity of the air around the object to be heated C detected by the humidity detection unit 8, and determines the cooking state of the object to be heated C. The control unit 12 controls the operation of the heating unit 5 based on the cooking state of the object to be heated C. In addition, the display unit 11 displays the cooking state of the object to be heated C.

The correcting method of the detection signal output by the electromagnetic wave detection unit 16 is merely one example, and the CPU 13 may perform calculation based on the detection signal of the electromagnetic wave detection unit 16, and then apply the output of the temperature detection unit 7 and the humidity detection unit 8 to a determination method of the cooking state.

When the change of the value after the error correction of the detection signal of the electromagnetic wave detection unit 16 per unit time calculated by the CPU 13 is smaller than a predetermined value, the control unit 12 controls the heating source 5 and completes the heating cooking.

Next, a controlling method of the heating source 5 by the control unit 12 will be described.

FIG. 4 and FIG. 5 are graphs showing outlines of the change of the detection signal of the electromagnetic wave detection unit 16 with respect to the heating time when the object to be heated C is heated. The correction of the effect of the error due to the temperature change of the object to be heated C with respect to the detection signal of the electromagnetic wave detection unit 16, and the error due to the water vapor around the object to be heated C are already completed. Depending on the material or the structure of the object to be heated C, the detection signal of the electromagnetic wave detection unit 16 may become stronger as the heating time elapses as shown in FIG. 4, or the detection signal of the electromagnetic wave detection unit 16 may become weaker as the heating time elapses as shown in FIG. 5.

As shown in FIG. 4 and FIG. 5, when the object to be heated C is heated, the intensity of the electromagnetic waves E changes and the detection signal of the electromagnetic wave detection unit 16 changes, due to evaporation of the moisture of the object to be heated C. In a case where the object to be heated C is sufficiently heated and the change in state of the object to be heated C become small, the change in intensity of the electromagnetic waves E and the change in the detection signal of the electromagnetic wave detection unit 16 also become small.

When the change in the detection signal of the electromagnetic wave detection unit 16 with respect to elapse of time, that is, a rate of change in the detection signal of the electromagnetic wave detection unit 16 of FIG. 4 and FIG. 5 is smaller than a predetermined value, the heating is completed at a timing shown by arrows in FIG. 4 and FIG. 5, for example. Accordingly, since the object to be heated C is not excessively heated, it is possible to prevent excessive scorching of the object to be heated C, for example.

A predetermined value relating to the rate of change in the detection signal of the electromagnetic wave detection unit 16, is different depending on the type of the object to be heated C, the scorched degree of the object to be heated C required by a user, or the scorched location. Accordingly, the set value is previously set for each cooking option corresponding to the object to be heated C, for example, and the corresponding set value may be selected when a user selects the cooking option.

The controlling method of the heating source 5 by the control unit 12 is merely one example, and is not limited thereto, and the control unit 12 may control the heating source 5 based on the absolute value of the detection signal, after correcting the detection signal of the electromagnetic wave detection unit 16, for example.

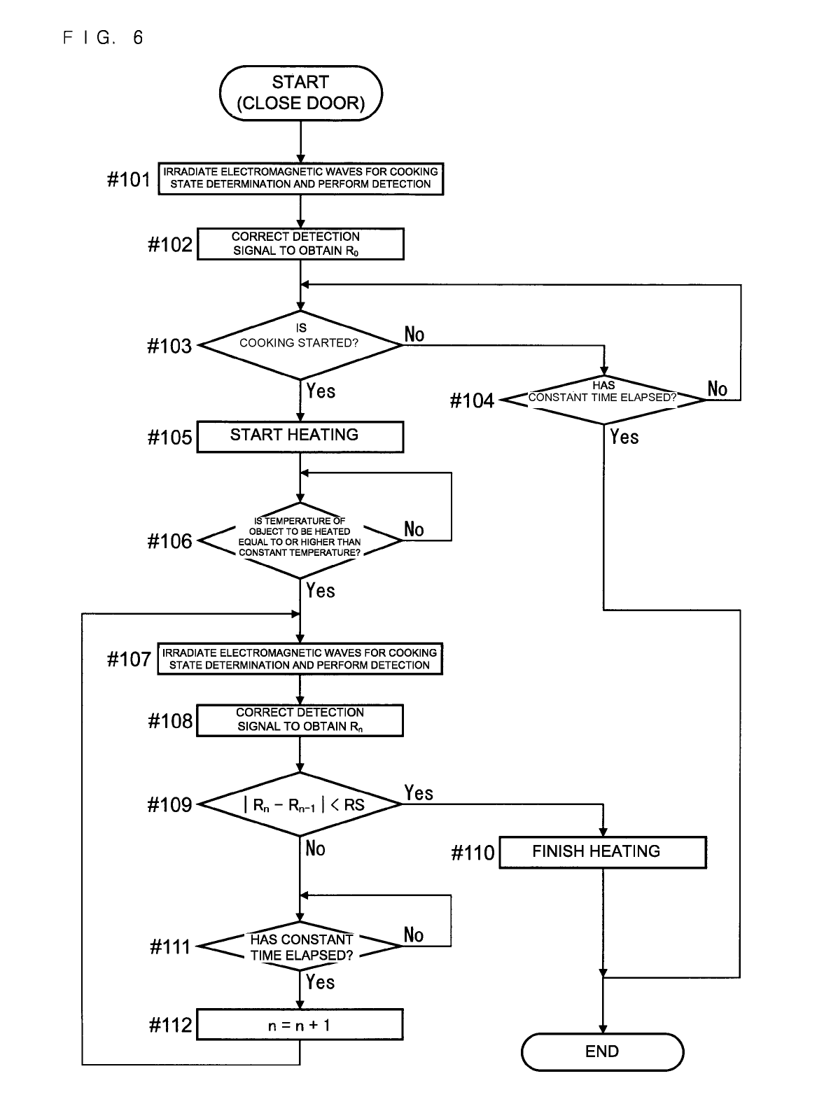

Next, the cooking operation of the heating cooking device 1 will be described through a flow shown in FIG. 6. FIG. 6 is a flowchart showing the cooking operation of the heating cooking device 1. In addition, this operation flow is merely one example, and the operation of the heating cooking device 1 is not limited thereto.

When the object to be heated C as the object to be cooked is accommodated in the heating chamber 3 of the heating cooking device 1 and the door 4 is closed (Start of FIG. 6), the electromagnetic waves E for determination of the cooking state are radiated towards the object to be heated C from the electromagnetic wave generation unit 15, and are detected by the electromagnetic wave detection unit 16 (Step #101 of FIG. 6).

The CPU 13 corrects the detection signal output by the electromagnetic wave detection unit 16, by using the temperature of the object to be heated C detected by the temperature detection unit 7 and the humidity of the air around the object to be heated C detected by the humidity detection unit 8 (Step #102). The size of the signal after the correction is set as R₀.

Next, the heating cooking device 1 determines whether or not the indication of the cooking start by a user is received from the operation unit 10 (Step #103). In a case where the indication of the cooking start is not received (No in Step #103), the detection signal output by the electromagnetic wave detection unit 16 is corrected in Step #102 and then it is determined whether or not a constant time has elapsed (Step #104). The constant time herein is predetermined and is stored in the storage unit 14 or the like.

When Steps #103 and #104 are repeated until the cooking start is indicated by a user and the constant time has elapsed (Yes in Step #104), the heating cooking device 1 allows the cooking operation to end with a result that no indication is received from a user (End of FIG. 6).

In a case where the cooking is started by the indication of a user in Step #103 (Yes in Step #103), the control unit 12 controls the heating unit 5 and starts the heating of the object to be heated C (Step #105). The temperature of the object to be heated C is detected by the temperature detection unit 7, and the heating is continued until the output of the temperature detection unit 7 is equal to or more than a predetermined reference value, that is, the temperature of the object to be heated C is equal to or higher than the predetermined constant temperature (No in Step #106). Through Step #106, it is possible to prevent completion of the cooking operation without changing the state of the object to be heated due to insufficient temperature increase of the object to be heated C. The constant temperature herein is stored in the storage unit 14 or the like.

When the temperature of the object to be heated C is equal to or higher than the predetermined constant temperature (Yes in Step #106), the electromagnetic waves E for determination of the cooking state are radiated towards the object to be heated C from the electromagnetic wave generation unit 15 and are detected by the electromagnetic wave detection unit 16 (Step #107).

The CPU 13 corrects the detection signal output by the electromagnetic wave detection unit 16 using the temperature of the object to be heated C detected by the temperature detection unit 7 and the humidity of the air around the object to be heated C detected by the humidity detection unit 8 (Step #108). The size of the signal after the correction is set as Rₙ and an initial value of n which is the number of times of detection of the electromagnetic wave detection unit 16 is set as 1.

Next, the CPU 13 determines whether or not the absolute value of a difference between the detection signals Rₙ and Rₙ₋₁ of the electromagnetic wave detection unit 16 corrected by the temperature and the humidity, is smaller than a predetermined reference value RS of the change in amount with respect to time of the detection signal (Step #109). The reference value RS herein is stored in the storage unit 14 or the like.

In a case where the absolute value of the difference between the detection signals Rₙ and Rₙ₋₁ is smaller than the reference value RS (Yes in Step #109), the control unit 12 controls the heating unit 5 and completes the heating of the object to be heated C (Step #110). The heating cooking device 1 allows the cooking operation to end (End of FIG. 6).

Meanwhile, in a case where the absolute value of the difference between the detection signals Rₙ and Rₙ₋₁ is not smaller than the reference value RS in Step #109 (No in Step #109), the heating of the object to be heated C is continued until a predetermined constant time has elapsed (Step #111). The constant time herein is stored in the storage unit 14 or the like.

When the constant time has elapsed in Step #111 (Yes in Step #111), 1 is added to the number of times of the detection n of the electromagnetic wave detection unit 16 (Step #112), and the process returns to Step #107 to perform the radiation and the detection of the electromagnetic waves E again.

As described above, the heating cooking device 1 includes the electromagnetic wave generation unit 15 which radiates the electromagnetic waves E having a frequency of 100 GHz to 120 THz towards the object to be heated C for determining the cooking state of the object to be heated C, the electromagnetic wave detection unit 16 which detects the electromagnetic waves E which are radiated by the electromagnetic wave generation unit 15, strike, and are reflected by or are scattered by the object to be heated C, and the CPU 13 which determines the cooking state of the object to be heated C based on the signal output by the electromagnetic wave detection unit 16 which detects the electromagnetic waves E. The electromagnetic waves E in a frequency band described above have a property of being easily absorbed as rotational movement of molecules, intermolecular interaction, or the like of sugars, proteins, fats, minerals, vitamins, water, and the like configuring food. Particularly, since the electromagnetic waves E in the frequency band described above have a property of being extremely easily absorbed by water molecules, the heating cooking device 1 can recognize the change in moisture content of the object to be heated C, by detecting electromagnetic waves E, an intensity of which is changed by striking and being reflected by or being scattered by the object to be heated C. Accordingly, the heating cooking device 1 can determine the cooking state which cannot be recognized from the appearance of the object to be heated C.

A constituent element of the food used for determining the cooking state of the object to be heated C is not limited to “water” described above, and may be any other constituent elements other than “water”.

It is desirable that the frequency of the electromagnetic waves E radiated by the electromagnetic wave generation unit 15 of the heating cooking device 1 be equal to or lower than 2.5 THz. Accordingly, it is possible to decrease the effect of the heat radiation generated when the temperature of the inside of the heating chamber 3 which is a heating space is increased.

In addition, since the heating cooking device 1 includes the exhaust unit 6 for discharging the gas in the heating chamber 3 to the outside, the effect on the absorption of the electromagnetic waves E by the water vapor or other gases in the heating chamber 3 is small. Accordingly, it is possible to more accurately perform the detection of the moisture content of the object to be heated C.

The heating cooking device 1 includes the humidity detection unit 8 which detects the humidity around the object to be heated C, and the CPU 13 corrects the signal output by the electromagnetic wave detection unit 16 using the humidity detected by the humidity detection unit 8. Accordingly, the absorption of the electromagnetic waves E by the water vapor around the object to be heated C, with respect to the detection signal of the electromagnetic waves E which strike and are reflected by or are scattered by the object to be heated C, can be corrected for. Therefore, it is possible to accurately perform the detection of the moisture content of the object to be heated C.

The heating cooking unit 1 includes the temperature detection unit 7 which detects the temperature of the object to be heated C, and the CPU 13 corrects the signal output by the electromagnetic wave detection unit 16 using the temperature detected by the temperature detection unit 7. Accordingly, the change in the absorbance of the electromagnetic waves E by the temperature change of the object to be heated C, with respect to the detection signal of the electromagnetic waves E which strike and are reflected by or are scattered by the object to be heated C, can be corrected for. Therefore, it is possible to accurately perform the detection of the moisture content of the object to be heated C.

Since the CPU 13 determines the cooking state of the object to be heated C based on the absolute value of the moisture content of the object to be heated C, that is, the signal output by the electromagnetic wave detection unit 16, it is possible to determine the amount of water molecules which is a detection target of the object to be heated C. Accordingly, it is possible to recognize the scorched degree of the surface of the object to be heated C, for example.

Since the CPU 13 determines the cooking state of the object to be heated C based on the change of the signal output by the electromagnetic wave detection unit 16 with respect to time, it is possible to determine whether or not the amount of water molecules which is a detection target of the object to be heated C is changed. Accordingly, it is possible to recognize the scorched degree of the surface of the object to be heated C, for example.

In addition, the heating cooking device 1 includes the predetermined reference value RS of the change in amount with respect to time of the signal output by the electromagnetic wave detection unit 16. It is possible to easily determine whether or not the amount of water molecules of the object to be heated C is changed, by comparing the reference value RS of the change in amount with respect to time of the output signal of the electromagnetic wave detection unit 16, and the change of the output signal of the electromagnetic wave detection unit 16 with respect to time. Accordingly, a scorched degree of the surface of the object to be heated C is simply recognized, for example.

In the heating cooking device 1, a predetermined reference value for the output of the temperature detection unit 7 is included, and the electromagnetic waves E for determining the cooking state of the object to be heated C are radiated towards the object to be heated C, under conditions that the output of the temperature detection unit 7 is equal to or larger than the reference value after starting cooking of the object to be heated C. Accordingly, it is possible to determine whether or not the amount of water molecules of the object to be heated C is changed, after the object to be heated C is sufficiently heated. Therefore, a scorched degree of the surface of the object to be heated C is properly recognized.

Since the heating cooking device 1 includes the control unit 12 which controls the operation of the heating unit 5, the operation of the heating unit 5 is controlled based on the cooking state of the object to be heated C determined by the CPU 13. Accordingly, it is possible to improve a heating quality of the object to be heated C.

Since the heating cooking device 1 includes the display unit 11 which displays the cooking state of the object to be heated C, a user can easily check the cooking state of the object to be heated C.

According to the configuration of the embodiment of the present invention, content of a constituent element of food which is the object to be heated C, for example, a moisture content is acquired, by detecting an intensity of the electromagnetic waves E which strike and are reflected by or are scattered by the object to be heated C. Accordingly, the heating cooking device 1 of the present invention can check the cooking state which cannot be recognized from an appearance of the object to be heated C. It is possible to provide the heating cooking device 1 which preferably controls heating with respect to the object to be heated C based thereon, to improve the heating quality.

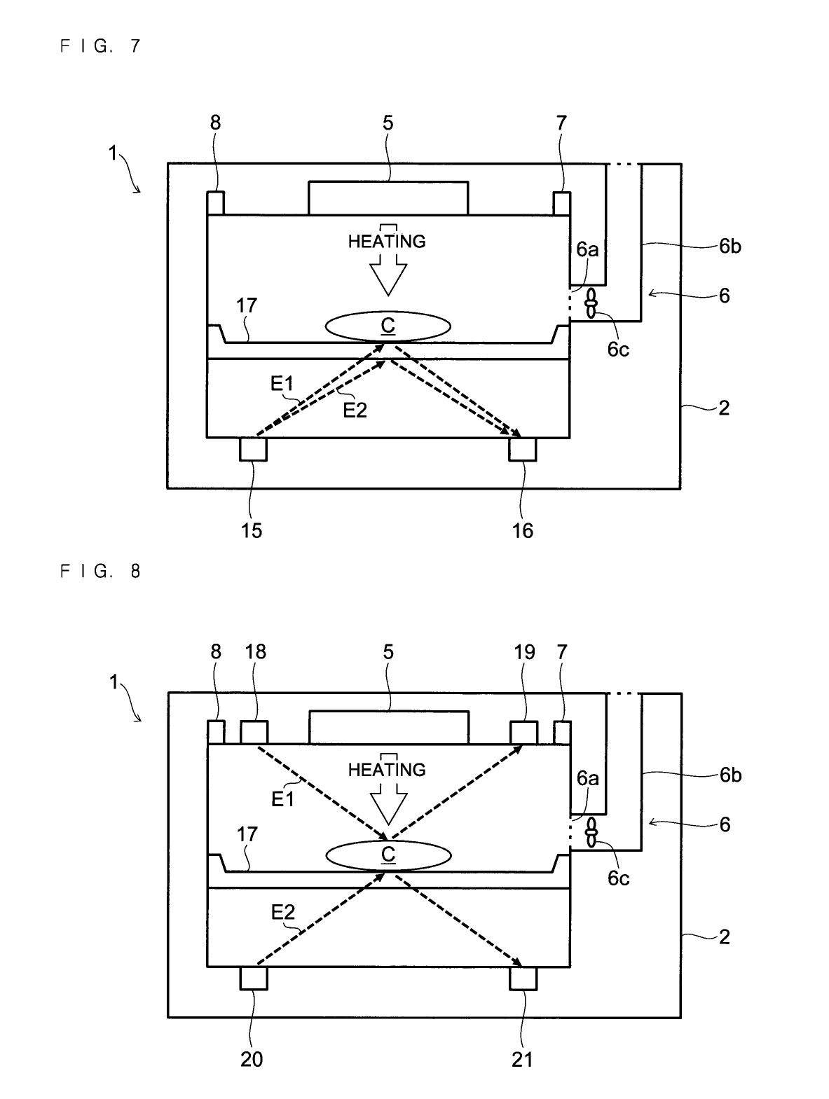

Next, a heating cooking device according to a second embodiment of the present invention will be described with reference to FIG. 7. FIG. 7 is a front view of a substantially vertical section of the heating cooking device. The basic configuration of this embodiment is the same as the first embodiment described with reference to FIG. 1 to FIG. 6, and therefore, the same reference numerals denote the constituent elements commonly used with the first embodiment, and the drawings and the description thereof will be omitted.

As shown in FIG. 7, in the heating cooking device 1 according to the second embodiment, the electromagnetic wave generation unit 15 and the electromagnetic wave detection unit 16 are disposed on a lower portion of the heating chamber 3. A plate-shaped support 17 which is a support member for supporting the object to be heated C from the upper portion of the bottom plate 3a, is provided in the heating chamber 3. Accordingly, the object to be heated C is present at substantially the center portion in the heating chamber 3 in a vertical direction.

The electromagnetic wave generation unit 15 radiates the electromagnetic waves E towards the object to be heated C in the portion above thereof, and radiates the electromagnetic waves E1 and E2 towards two different points. One of electromagnetic waves E1 radiated by the electromagnetic wave generation unit 15 strikes the object to be heated C from the lower side, and the other of electromagnetic waves E2 strikes a portion which is not the object to be heated C. To be accurate, the electromagnetic waves E1 strike a contacting portion of the object to be heated C and the support 17, and the electromagnetic waves E2 strike a non-contacting portion of the support 17 and the object to be heated C (lower surface of the support 17). The electromagnetic waves E1 and E2 have substantially the same length of radiation path, that is, a path from the electromagnetic wave generation unit 15 to the electromagnetic wave detection unit 16.

Since the electromagnetic wave generation unit 15 radiates the electromagnetic waves E1 and E2 radiated towards the two portions at different timings, one electromagnetic wave detection unit 16 is provided and can detect each of the electromagnetic waves E1 and E2 individually.

In addition, the support 17 is formed from a material which the electromagnetic waves E penetrate. For example, as the material of the support 17, pottery, glass, or plastic may be used. The support is necessary to be transparent in a case of detecting the cooking state of the object to be heated with visible light. However, since the support 17 is not necessarily transparent in the embodiment, the range of choices of the material used for the support 17 is widened.

According to the configuration of the second embodiment as described above, the electromagnetic waves E are radiated towards two different points from the electromagnetic wave generation unit 15, and the plurality of detection signals corresponding to the electromagnetic waves E are output by the electromagnetic wave detection unit 16, and accordingly the heating cooking device 1 obtains detection signals of the electromagnetic waves E1 striking the object to be heated C and the electromagnetic waves E2 not striking the object to be heated C. It is possible to increase accuracy of the moisture content of the object to be heated C to be detected, by comparing the detection signals of the electromagnetic waves E1 and E2 obtained from two portions.

As described above, the lengths of the radiation paths of the electromagnetic waves E1 and E2 radiated towards the two portions are substantially the same as each other. Accordingly, it is possible to correct the detection signals of the electromagnetic waves E1 and E2 affected by the temperature of the object to be heated C or the water vapor around the object to be heated C, by acquiring a difference between the electromagnetic waves E1 and E2 having the same length of radiation path.

The electromagnetic waves E1 and E2 radiated towards the two different points strike the contacting portion of the object to be heated C and the support 17, and the non-contacting portion of the support 17 and the object to be heated C. Accordingly, it is possible to correct the detection signals of the electromagnetic waves E1 and E2 affected by the temperature of the object to be heated C or the water vapor around the object to be heated C, by acquiring a difference between the electromagnetic waves E1 and E2 striking these portions.

In a case where the control unit 12 controls the heating unit 5 based on an absolute value of the difference between the detection signals of the electromagnetic wave detection unit 16 per unit time calculated by the CPU 13 in relation to each of the electromagnetic waves E1 and E2, it is desirable to correct for the error due to the temperature change of the support 17. The temperature of the support 17, for example, may be measured by newly providing a temperature sensor such as a thermistor.

As the support member supporting the object to be heated C, another container may be used, instead of the support 17. A material of the container is the same as the material of the support 17. In this case, the electromagnetic waves E1 and E2 are radiated towards the container, and strike a contacting portion of the object to be heated C and the container and a non-contacting portion of the container and the object to be heated C.

The radiation portions of the electromagnetic waves E are not limited to two portions and may be three or more portions. For example, the electromagnetic waves E may be radiated towards the entirety of the object to be heated C.

Next, a heating cooking device according to a third embodiment of the present invention will be described with reference to FIG. 8. FIG. 8 is a front view of a substantially vertical section of the heating cooking device. The basic configuration of this embodiment is the same as the first embodiment and the second embodiment, and therefore, the same reference numerals denote the constituent elements commonly used with the embodiments described above, and the drawings and the description thereof will be omitted.

As shown in FIG. 8, the heating cooking device 1 according to the third embodiment includes the plate-shaped support 17 for supporting the object to be heated C from the upper portion of the bottom plate 3a of the heating chamber 3. The object to be heated C is loaded on the support 17.

A first electromagnetic wave generation unit 18 and a first electromagnetic wave detection unit 19 are disposed on the upper portion of the heating chamber 3. The electromagnetic waves E1 radiated by the first electromagnetic wave generation unit 18 towards the object to be heated C in a portion therebelow, is reflected by or scattered by the upper side of the object to be heated C, and is detected by the first electromagnetic wave detection unit 19. The electromagnetic waves E1 strike the non-contacting portion of the object to be heated C and the support 17.

A second electromagnetic wave generation unit 20 and a second electromagnetic wave detection unit 21 are disposed on the lower portion of the heating chamber 3. The electromagnetic waves E2 radiated by the second electromagnetic wave generation unit 20 towards the object to be heated C in a portion thereabove, is reflected by or scattered by the lower side of the object to be heated C, and is detected by the second electromagnetic wave detection unit 21. The electromagnetic wave E2 strike the contacting portion of the object to be heated C and the support 17.

The length of the radiation path of the electromagnetic waves E1, that is, the path from the first electromagnetic wave generation unit 18 to the first electromagnetic wave detection unit 19, and the length of the radiation path of the electromagnetic waves E2, that is, the path from the second electromagnetic wave generation unit 20 to the second electromagnetic wave detection unit 21 are substantially the same as each other.

According to the configuration of the third embodiment described above, the electromagnetic waves E1 and E2 radiated towards the two different points strike the contacting portion of the object to be heated C and the support 17 and the non-contacting portion of the object to be heated C and the support 17. Accordingly, it is possible to correct the detection signals of the electromagnetic waves E1 and E2 affected by the temperature of the object to be heated C or the water vapor around the object to be heated C, by acquiring the difference between the electromagnetic waves E1 and E2 striking the portions. Therefore, it is possible to further increase the accuracy of the moisture content of the object to be heated C.

In addition, when a cooking state of a certain portion of the object to be heated C substantially does not change before and after the heating, for example, by setting a detection signal of this portion as a reference, it is possible to correct the detection signal of the electromagnetic waves E of another portion which is easily affected by the temperature of the object to be heated C or the water vapor around the object to be heated C.

In a case where the control unit 12 controls the heating unit 5 based on an absolute value of the difference between the detection signals of the electromagnetic wave detection unit 16 per unit time calculated by the CPU 13 in relation to each of the electromagnetic waves E1 and E2, it is desirable to correct for the error due to the temperature change of the support 17. The temperature of the support 17, for example, may be measured by newly providing a temperature sensor such as a thermistor.

The radiation portions of the electromagnetic waves E are not limited to two portions and may be three or more portions. For example, the electromagnetic waves E may be radiated towards the entirety of the object to be heated C.

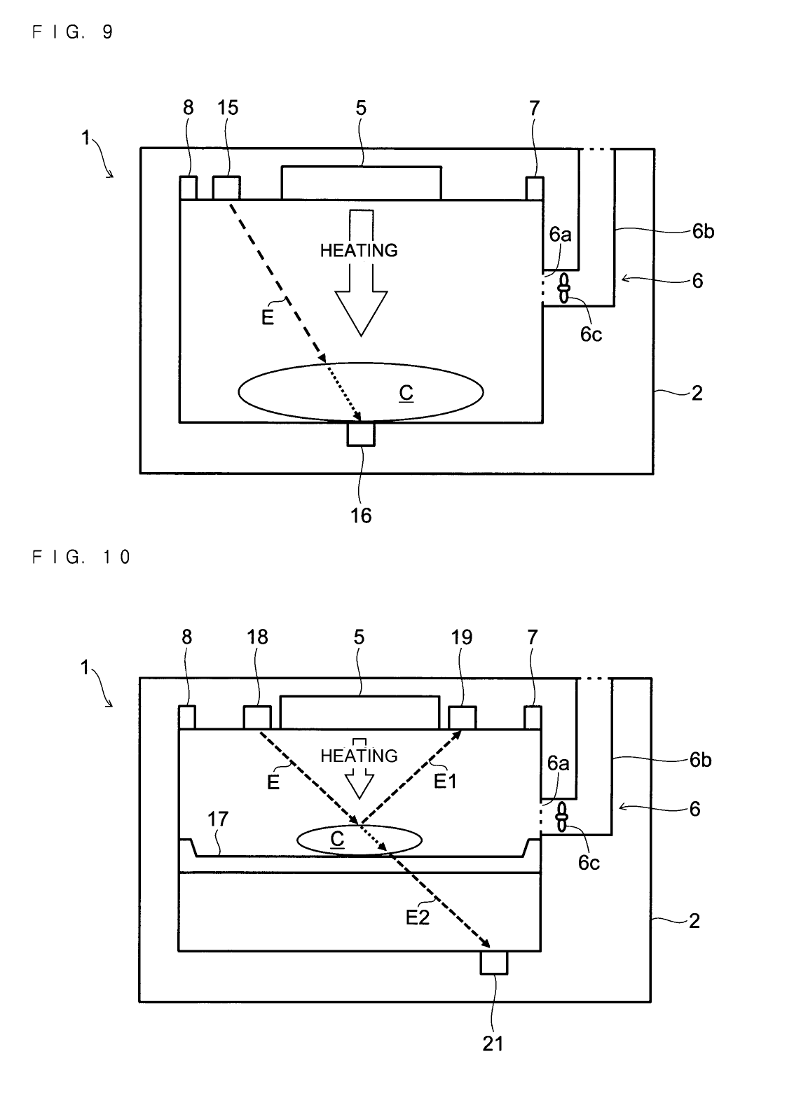

Next, a heating cooking device according to a fourth embodiment of the present invention will be described with reference to FIG. 9. FIG. 9 is a front view of a substantially vertical section of the heating cooking device. The basic configuration of this embodiment is the same as the first embodiment described with reference to FIG. 1 to FIG. 6, and therefore, the same reference numerals denote the constituent elements commonly used with the first embodiment, and the drawings and the description thereof will be omitted.

As shown in FIG. 9, in the heating cooking device 1 according to the fourth embodiment, the electromagnetic wave detection unit 16 is disposed at substantially the center portion of the lower portion of the heating chamber 3. That is, the electromagnetic wave generation unit 15 and the electromagnetic wave detection unit 16 are disposed so as to face each other with the heating chamber 3 interposed therebetween. The electromagnetic waves E radiated by the electromagnetic wave generation unit 15 towards the object to be heated C in a portion therebelow pass through the object to be heated C loaded on the bottom plate 3a of the heating chamber 3 and then are detected by the electromagnetic wave detection unit 16.

Also in the configuration of the fourth embodiment, the heating cooking device 1 detects the electromagnetic waves E, an intensity of which is changed by striking and passing through the object to be heated C, and accordingly it is possible to recognize the change of the moisture content of the object to be heated C. Therefore, the heating cooking device 1 can recognize the cooking state which cannot be recognized from the appearance of the object to be heated C.

The heating cooking device 1 can correct for the absorption of the electromagnetic waves E by the water vapor around the object to be heated C with respect to the detection signal of the electromagnetic waves E which strike and pass through the object to be heated C. In addition, it is possible to correct for the change in the absorbance of the electromagnetic waves E due to the temperature change of the object to be heated C with respect to the detection signal of the electromagnetic waves E which strike and pass through the object to be heated C. Accordingly, it is possible to accurately detect the moisture content of the object to be heated C.

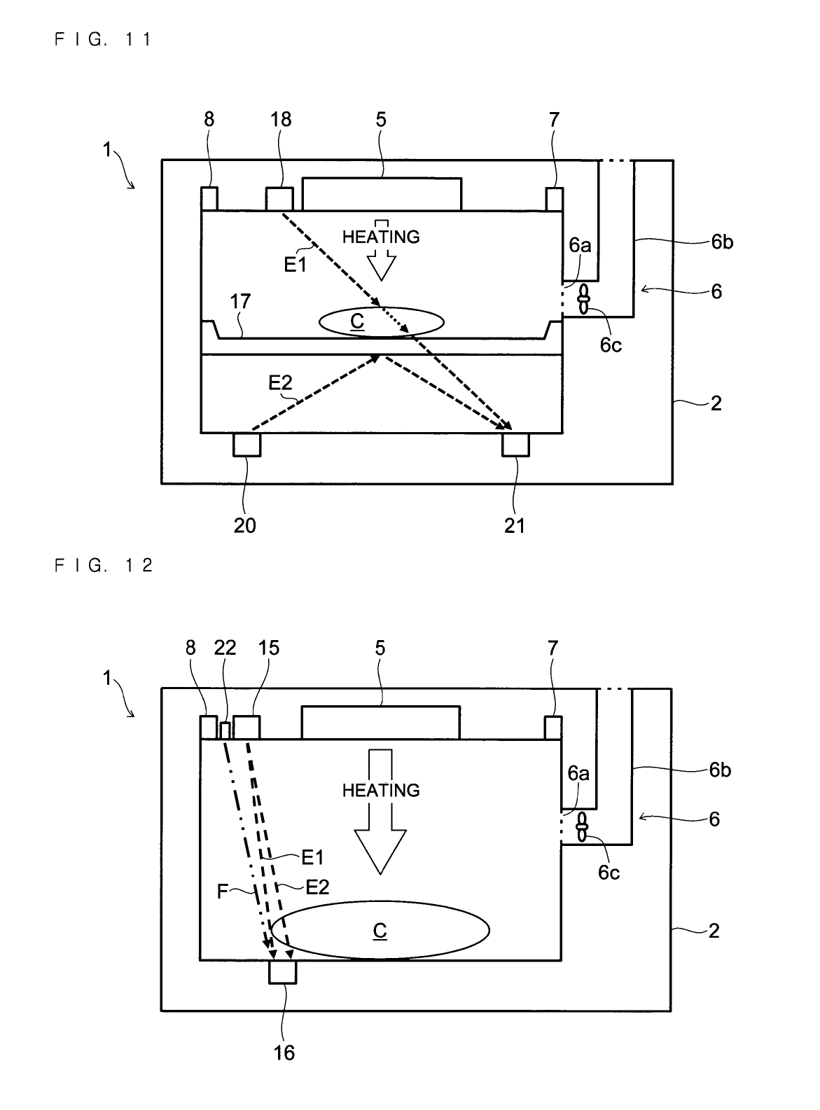

Next, a heating cooking device according to a fifth embodiment of the present invention will be described with reference to FIG. 10. FIG. 10 is a front view of a substantially vertical section of the heating cooking device. The basic configuration of this embodiment is the same as the first embodiment to the fourth embodiment described above, and therefore, the same reference numerals denote the constituent elements commonly used with these embodiments, and the drawings and the description thereof will be omitted.

As shown in FIG. 10, the heating cooking device 1 according to the fifth embodiment includes the plate-shaped support 17 for supporting the object to be heated C from the upper portion of the bottom plate 3a of the heating chamber 3. The object to be heated C is loaded on the support 17. In addition the electromagnetic wave generation unit 15 is disposed on the upper portion of the heating chamber 3.

The first electromagnetic wave detection unit 19 is disposed on the upper portion of the heating chamber 3. The electromagnetic waves E radiated by the electromagnetic wave generation unit 15 towards the object to be heated C in a portion therebelow are reflected by or scattered by the upper side of the object to be heated C and are detected by the first electromagnetic wave detection unit 19 as the electromagnetic waves E1.

The second electromagnetic wave detection unit 21 is disposed on the lower portion of the heating chamber 3. The electromagnetic waves E radiated by the electromagnetic wave generation unit 15 towards the object to be heated C in a portion therebelow pass through the object to be heated C and are detected by the second electromagnetic wave detection unit 21 as the electromagnetic waves E2.

Also in the configuration of the fifth embodiment, the heating cooking device 1 detects the electromagnetic waves E1 and E2, intensities of which are changed by striking and being reflected by, being scattered by, or passing through the object to be heated C, and accordingly it is possible to recognize the change of the moisture content of the object to be heated C. Therefore, it is possible to increase the accuracy of the moisture content of the object to be heated C.

Next, a heating cooking device according to a sixth embodiment of the present invention will be described with reference to FIG. 11. FIG. 11 is a front view of a substantially vertical section of the heating cooking device. The basic configuration of this embodiment is the same as the first embodiment to the fifth embodiment described above, and therefore, the same reference numerals denote the constituent elements commonly used with these embodiments, and the drawings and the description thereof will be omitted.

As shown in FIG. 11, the heating cooking device 1 according to the sixth embodiment includes the plate-shaped support 17 for supporting the object to be heated C from the upper portion of the bottom plate 3a of the heating chamber 3. The object to be heated C is loaded on the support 17. The electromagnetic wave detection unit 16 is disposed on a lower portion of the heating chamber 3.

The first electromagnetic wave generation unit 18 is disposed on the upper portion of the heating chamber 3. The electromagnetic waves E1 radiated by the first electromagnetic wave generation unit 18 towards the object to be heated C in a portion therebelow, pass through the object to be heated C and are detected by the electromagnetic wave detection unit 16.

The second electromagnetic wave generation unit 20 is disposed on the lower portion of the heating chamber 3. The electromagnetic waves E2 radiated by the second electromagnetic wave generation unit 20 towards the object to be heated C in the portion above thereof, are reflected or scattered by the lower side of the support 17 and are detected by the electromagnetic wave detection unit 16.

Also in the configuration of the sixth embodiment, the heating cooking device 1 detects the electromagnetic waves E1, an intensity of which is changed by striking and passing through the object to be heated C, and the electromagnetic waves E2 not striking the object to be heated C, and accordingly it is possible to recognize the change of the moisture content of the object to be heated C. Therefore, it is possible to increase the accuracy of the moisture content of the object to be heated C.

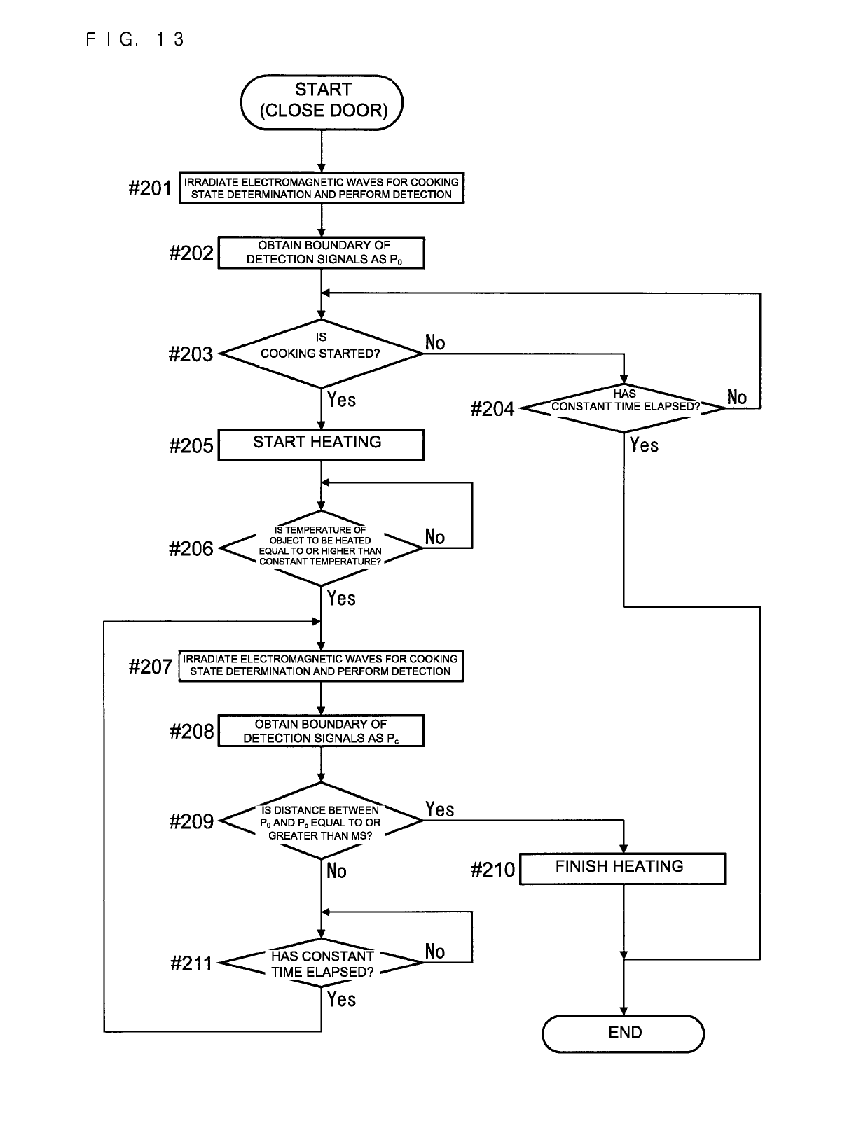

Next, a heating cooking device according to a seventh embodiment of the present invention will be described with reference to FIG. 12 and FIG. 13. FIG. 12 is a front view of a substantially vertical section of the heating cooking device, and FIG. 13 is a flowchart showing the cooking operation of the heating cooking device. The basic configuration of this embodiment is the same as the first embodiment to the sixth embodiment described above, and therefore, the same reference numerals denote the constituent elements commonly used with these embodiments, and the drawings and the description thereof will be omitted.

As shown in FIG. 12, in the heating cooking device 1 according to the seventh embodiment, the electromagnetic wave generation unit 15 is disposed on the upper portion of the heating chamber 3, and the electromagnetic wave detection unit 16 is disposed on the lower portion of the heating chamber 3. The electromagnetic wave generation unit 15 radiates the electromagnetic waves E1 and E2 to two portions detectable by the electromagnetic wave detection unit 16.

The electromagnetic waves E1 pass through the outer side of the periphery portion of the object to be heated C and are detected by the electromagnetic wave detection unit 16. The electromagnetic waves E2 pass through the inner side of the periphery portion of the object to be heated C and are detected by the electromagnetic wave detection unit 16. However, the electromagnetic waves E2 are absorbed by the moisture of the object to be heated C and are not detected by the electromagnetic wave detection unit 16 before the cooking or in an initial stage of cooking. As the heating cooking proceeds, and the amount of moisture of the object to be heated C is decreased, the electromagnetic waves pass through the object to be heated C and are detected.

By using this, for example, the electromagnetic waves E are radiated towards the entirety of the object to be heated C before the heating cooking, and a boundary between locations of the electromagnetic waves E detectable and non-detectable by the electromagnetic wave detection unit 16 is calculated by the CPU 13 and is stored in the storage unit 14 or the like. Even during the heating cooking, the electromagnetic waves E are radiated towards the entirety of the object to be heated C in the same manner as described above, and in a case where the boundary moves by a predetermined distance from the stored location, the heating source 5 may be controlled by the control unit 12 so as to end the heating. That is, the CPU 13 determines the cooking state of the object to be heated C based on the change in the location of the electromagnetic waves E detectable by the electromagnetic wave detection unit 16.

The radiation location of the electromagnetic waves E with respect to the object to be heated C may be changed. That is, in a setting method of the location of the object to be heated C through which the electromagnetic waves E do not pass before the heating cooking but the electromagnetic waves E do pass after the heating cooking, the location may be searched for and set by radiating the electromagnetic waves E to the object to be heated C.

In addition, an indication unit 22 which indicates the radiation location of the electromagnetic waves E may be provided. The indication unit 22 is configured with illumination or the like, and a user can check the radiation location of the electromagnetic waves E by visible light F being emitted to the radiation location of the electromagnetic waves E. A two-dot chain line drawn in FIG. 12 shows the visible light F emitted by the indication unit 22. The location of the object to be heated C through which the electromagnetic waves E do not pass before the heating cooking but the electromagnetic waves E do pass after the heating cooking may be adjusted, by using the location indicated by the indication unit 22 as a reference.

Next, the cooking operation of the heating cooking device 1 will be described through a flow shown in FIG. 13. FIG. 13 is a flowchart showing the cooking operation of the heating cooking device 1. In addition, this operation flow is merely one example, and the operation of the heating cooking device 1 is not limited thereto.

When the object to be heated C as the object to be cooked is accommodated in the heating chamber 3 of the heating cooking device 1 and the door 4 is closed (Start of FIG. 13), the electromagnetic waves E for determination of the cooking state are radiated towards the object to be heated C from the electromagnetic wave generation unit 15, and the detection of the electromagnetic waves E is attempted by the electromagnetic wave detection unit 16 (Step #201 of FIG. 13).

The CPU 13 calculates the boundary between the locations at which the electromagnetic waves E radiated towards the object to be heated C can be detected and cannot be detected by the electromagnetic wave detection unit 16 (Step #202). A location of this boundary is set as P₀.

Next, the heating cooking device 1 determines whether or not the indication of the cooking start by a user is received from the operation unit 10 (Step #203). In a case where the indication of the cooking start is not received (No in Step #203), the boundary location P₀ is calculated in Step #202, and then it is determined whether or not a constant time has elapsed (Step #204). The constant time herein is predetermined and is stored in the storage unit 14 or the like.

Since Steps #203 and #204 are repeated until the cooking start is indicated by a user and the constant time has elapsed (Yes in Step #204), the heating cooking device 1 allows the cooking operation to end with a result that no indication of cooking is received from a user (End of FIG. 13).

In a case where the cooking is started by the indication of a user in Step #203 (Yes in Step #203), the control unit 12 controls the heating unit 5 and starts the heating of the object to be heated C (Step #205). The temperature of the object to be heated C is detected by the temperature detection unit 7, and the heating is continued until the output of the temperature detection unit 7 is equal to or more than the predetermined reference value, that is, the temperature of the object to be heated C is equal to or higher than the predetermined constant temperature (No in Step #206). Through Step #206, it is possible to prevent completion of the cooking operation without changing the state due to insufficient temperature increase of the object to be heated C. The constant temperature herein is stored in the storage unit 14 or the like.

When the temperature of the object to be heated C is equal to or higher than the predetermined constant temperature (Yes in Step #206), the electromagnetic waves E for determination of the cooking state are radiated towards the object to be heated C from the electromagnetic wave generation unit 15 and the detection of the electromagnetic waves E is attempted by the electromagnetic wave detection unit 16 (Step #207).

The CPU 13 calculates the boundary between the locations at which the electromagnetic waves E radiated towards the object to be heated C can be detected and cannot be detected by the electromagnetic wave detection unit 16 (Step #208). A location of this boundary is set as P_{C}.

Then, the CPU 13 determines whether or not a distance between the value P₀ before the heating cooking and the value P_{C} during the heating cooking of the boundary between the locations at which the electromagnetic waves E can be detected and cannot be detected by the electromagnetic wave detection unit 16, is equal to or greater than a predetermined reference value MS (Step #209). The reference value MS of the distance herein is stored in the storage unit 14 or the like.

In a case where the distance between the boundary locations P₀ and P_{C} is equal to or greater than the reference value MS (Yes in Step #209), the control unit 12 controls the heating unit 5 and finishes the heating of the object to be heated C (Step #210). The heating cooking device 1 allows the cooking operation to end (End of FIG. 13).

On the other hand, in a case where the distance between the boundary locations P₀ and P_{C} is smaller than the reference value MS (No in Step #209), the heating of the object to be heated C is continued until a predetermined constant time elapses (Step #211). The constant time herein is stored in the storage unit 14 or the like.

When the constant time has elapsed in Step #211 (Yes in Step #211), the process returns to Step #207 to perform the radiation and the detection of the electromagnetic waves E again.

According to the configuration of the seventh embodiment described above, the electromagnetic wave detection unit 16 detects the electromagnetic waves E passing through the object to be heated C, and the CPU 13 determines the cooking state of the object to be heated C based on the change in the location at which the electromagnetic waves E passing through the object to be heated C are detectable by the electromagnetic wave detection unit 16. That is, the CPU 13 calculates the boundary of the locations between which the electromagnetic waves E can be detected and cannot be detected by the electromagnetic wave detection unit 16. In addition, the CPU 13 calculates that the location at which the electromagnetic waves E passing through the object to be heated C cannot be detected before the cooking or in the initial stage of cooking, is displaced due to decreased moisture of the object to be heated C as the heating cooking proceeds. Accordingly, the CPU 13 can determine the cooking state of the object to be heated C based on the change in location of the electromagnetic waves E detectable by the electromagnetic wave detection unit 16.

Since the radiation location of the electromagnetic waves E with respect to the object to be heated C changes, location information relating to the disposition of the object to be heated C in the heating chamber 3 can be obtained. Accordingly, it is possible to radiate the electromagnetic waves E with respect to the preferred location of the object to be heated C in order to check the cooking state of the object to be heated C. Therefore, it is possible to accurately check the cooking state of the object to be heated C.

Since the heating cooking device 1 includes the indication unit 22 configured with illumination or the like which indicates the radiation location of the electromagnetic waves E, a user can check the radiation location of the electromagnetic waves E. Accordingly, the object to be heated C is easily disposed at the preferred location of the object to be heated C, so as to be struck by the electromagnetic waves E, in order to check the cooking state of the object to be heated C. Therefore, it is possible to accurately check the cooking state of the object to be heated C.

Hereinabove, the embodiments of the present invention have been described, but the range of the present invention is not limited thereto, and the embodiments can be performed by adding various modifications within a range not departing from a gist of the invention.

In the embodiments described above, the heating cooking device 1 such as a microwave oven or a microwave including the heating chamber 3 closed by the door 4 has been described as an example, but the application item of the present invention is not limited to the heating cooking device including the heating chamber, and the invention can also be applied to a heating cooking device not including the heating chamber such as an IH cooking heater or a hot plate.

### INDUSTRIAL APPLICABILITY

The present invention can be used for a heating cooking device which performs heating cooking with respect to an object to be heated. For example, the invention can be used for a microwave oven, a toaster oven, a water oven, a grill cooker, a microwave, a rice cooker, an IH cooking heater, a hot plate, or the like.

### REFERENCE SIGNS LIST

1 HEATING COOKING DEVICE
2 MAIN BODY HOUSING
3 HEATING CHAMBER
4 DOOR
5 HEATING UNIT
6 EXHAUST UNIT
7 TEMPERATURE DETECTION UNIT
8 HUMIDITY DETECTION UNIT
10 OPERATION UNIT
11 DISPLAY UNIT
12 CONTROL UNIT
13 CPU (CALCULATION UNIT)
14 STORAGE UNIT
15 ELECTROMAGNETIC WAVE GENERATION UNIT
16 ELECTROMAGNETIC WAVE DETECTION UNIT
17 SUPPORT (SUPPORT MEMBER)
18 FIRST ELECTROMAGNETIC WAVE GENERATION UNIT
19 FIRST ELECTROMAGNETIC WAVE DETECTION UNIT
20 SECOND ELECTROMAGNETIC WAVE GENERATION UNIT
21 SECOND ELECTROMAGNETIC WAVE DETECTION UNIT
22 INDICATION UNIT
E ELECTROMAGNETIC WAVES

1: A heating cooking device comprising:
a heating unit which heats an object to be heated;
an electromagnetic wave generation unit which radiates electromagnetic waves having a frequency of 100 GHz to 120 THz towards the object to be heated for determining a cooking state of the object to be heated;
an electromagnetic wave detection unit which detects the electromagnetic waves radiated by the electromagnetic wave generation unit; and
a calculation unit which determines a cooking state of the object to be heated based on a signal output by the electromagnetic wave detection unit which detects the electromagnetic waves.

2: The heating cooking device according to claim 1, wherein the frequency of the electromagnetic waves is equal to or lower than 2.5 THz.

3: The heating cooking device according to claim 1, further comprising:
a heating chamber which accommodates the object to be heated; and
an exhaust unit for discharging gas in the heating chamber to the outside.

4: The heating cooking device according to claim 1, wherein the electromagnetic waves are radiated towards a plurality of different points, and a plurality of the signals corresponding to the respective electromagnetic waves are output by the electromagnetic wave detection unit.

5: The heating cooking device according to claim 4, wherein lengths of radiation paths of the electromagnetic waves radiated towards the plurality of different points, are substantially the same.

6: The heating cooking device according to claim 4, wherein the electromagnetic waves radiated towards the plurality of different points strike a contacting portion of the object to be heated and a support member which supports the object to be heated, and a non-contacting portion of the support member and the object to be heated.

7: The heating cooking device according to claim 4, wherein the electromagnetic waves radiated towards the plurality of different points strike a contacting portion of the object to be heated and a support member which supports the object to be heated, and a non-contacting portion of the object to be heated and the support member.

8: The heating cooking device according to claim 1, further comprising:
a humidity detection unit which detects a humidity around the object to be heated,
wherein the calculation unit corrects the signal output by the electromagnetic wave detection unit using the humidity detected by the humidity detection unit.

9: The heating cooking device according to claim 1, further comprising:
a temperature detection unit which detects a temperature of the object to be heated,
wherein the calculation unit corrects the signal output by the electromagnetic wave detection unit using the temperature detected by the temperature detection unit.

10: The heating cooking device according to claim 1, wherein the calculation unit determines a cooking state of the object to be heated based on an absolute value of the signal output by the electromagnetic wave detection unit.

11: The heating cooking device according to claim 1, wherein the calculation unit determines a cooking state of the object to be heated based on a change of the signal output by the electromagnetic wave detection unit with respect to time.

12: The heating cooking device according to claim 11, wherein a predetermined reference value for an amount of change of the signal output by the electromagnetic wave detection unit with respect to time is included.

13: The heating cooking device according to claim 1,
wherein the electromagnetic wave detection unit detects the electromagnetic waves passing through the object to be heated, and
the calculation unit determines a cooking state of the object to be heated based on a change in location of the electromagnetic waves passing through the object to be heated, which is detectable by the electromagnetic wave detection unit.

14: The heating cooking device according to claim 13, wherein a radiation location of the electromagnetic waves changes.

15: The heating cooking device according to claim 13, further comprising an indicating unit which indicates a radiation location of the electromagnetic waves.

16: The heating cooking device according to claim 9,
wherein a predetermined reference value for the output of the temperature detection unit is included, and
the electromagnetic waves for determining the cooking state of the object to be heated are radiated towards the object to be heated, under conditions that the output of the temperature detection unit is equal to or larger than the reference value after starting cooking of the object to be heated.

17: The heating cooking device according to claim 1, further comprising a control unit which controls an operation of the heating unit.

18: The heating cooking device according to claim 1, further comprising a display unit which displays the cooking state of the object to be heated.
